(19) United States
(12) Patent Application Publication
(10) Pub. No.: US 2010/0132215 A1
(43) Pub. Date: Jun. 3, 2010

(54) METHOD AND APPARATUS FOR CONTAMINATION-FREE LOADING AND EMPTYING

(76) Inventor: Richard Denk, Scheyern (DE)

Correspondence Address: HEAD, JOHNSON & KACHIGIAN, 228 W 17TH PLACE, TULSA, OK, 74119, US

(21) Appl. No.: 12/733,006

(22) PCT Filed: Aug. 22, 2008
(86) PCT No.: PCT/EP2008/061048

§ 371 Date: Jan. 29, 2010

(30) Foreign Application Priority Data
Dec. 11, 2003 (DE) 103-58-037.9
Feb. 6, 2004 (DE) 10-2004-005-961.6

(51) Int. Cl. F26B 7/00; F26B 11/02; F26B 19/00; F26B 3/02

(52) U.S. Cl. 34/389; 34/130; 34/85; 34/499

(57) ABSTRACT

In a mixer, in particular a tumbling mixer, the components to be mixed often still have to be dried during mixing, therefore the wall portions of the mixer are air permeable for force inducting drying air. In order to operate such a mixer contamination free for the ambient, it is proposed to cover the portions of the mixer with permeable walls on the outside with a cover, in particular a flexible foil, which is held tight at the mixer above and below the air permeable portions, so that drying air can be inducted between the foil and the mixer into the air permeable portions. Subsequently, the contaminated foil and the drum are provided to reprocessing or disposal.

### I. FIELD OF THE INVENTION

The invention relates to devices and equipment, in particular to a mixer, a granulator or a dryer, which are to be loaded and emptied contamination free.

### II. TECHNICAL BACKGROUND

In particular in the pharmaceutical industry, but also in the chemical industry, substances have to be handled quite frequently, which include toxic substances, e.g. they have to be mixed, granulated or dried.

Thus, there is a problem in that, though the mixer can be closed tight during mixing and no toxic or other undesired substances (cross contamination) can penetrate towards the outside or towards the inside to the product, the ambient, however, is contaminated at the latest when the mixer is opened.

Therefore this type of equipment, subsequently only mixers are recited, without the invention being limited thereto, is disposed in rooms up to now, which in turn are sealed respectively relative to the ambient in order not to let contaminations penetrating into the surrounding mixing room penetrate further outward into the ambient or contaminate the product.

This, however, significantly increases the ensuing complexity, e.g. for mixing such substances, since not only the mixer itself needs to be cleaned after mixing, but also the mixer cavity, in which the mixer was disposed, when the mixer was opened and emptied after its operation.

In addition, further processing steps have to be performed along with the mixing or after the mixing, such as granulating, coating of the granulate with a lubricant or drying, e.g. after producing the granulate, wherein the same problems occur in these processing steps as during the actual mixing.

When the raw material is a powdery substance as usual, the mixing is performed in a mixing drum mostly in two stages, thus on the one hand through a coarse mixing, caused by a rotational motion or a tumbling motion of the closed mixing drum, and on the other hand by a subsequent fine mixing.

For this purpose, the walls of the mixing drum are at least in sections made of a material, e.g. a sintered material, which is not permeable for the substances to be mixed, mostly solids, more rarely liquids, which, however, is permeable for air, preferably only in the flow direction, from the outside to the inside, thus into the mixer.

This way air in large volumes and also under sufficient pressure can be pressed into the mixer from the outside through these partially permeable wall portions, whereby e.g. powdery contents inside the mixer are swirled around intensely and mixed completely.

Since this may cause the risk of a dust explosion, depending on the substances to be mixed, this fine mixing is performed in a pressure container as a general rule in order to absorb the explosion pressure in case of an explosion by means of the pressure container.

The problem of these partly permeable wall portions is that theoretically none of the contents of the mixer can permeate them from the inside towards the outside, but the manufacturers only guarantee a reliability below the 100% mark, so that the possibility of a contamination of the space outside of the mixer cannot be excluded, since, minutest quantities may still penetrate from the inside of the mixer through the partly permeable wall portions to the outside.

The drum of the mixer is closed tight correctly through the tight circumferential cover of the at least partially permeable wall portions, when all other inserts and outlets are properly closed, so that even in case of a penetration of contents through the partly permeable wall portions from the inside towards the outside, no contamination of the ambient is performed.

This cover can be a firm lid with a stable shape, as known from DE 32 06 385 A1 and DE 37 39 976 A1.

### III. DESCRIPTION OF THE INVENTION

### a) Technical Object

Thus, it is the object of the invention to provide a device, like e.g. a mixer and a method is for its operation, by means of which also toxic substances can be mixed with comparatively low complexity, emptied subsequently, and the mixer can be prepared for further use.

### b) Solution

This object is accomplished through the features of claims 1 and 29. Advantageous embodiments can be derived from the dependent claims.

The foil or the lid, thus reach over the partially permeable edge portions on the outside of the drum, and contact the outside of the drum for this purpose circumferentially tight, outside of the partially permeable wall portions, and thus both above and below the permeable edges, when it concerns an annular wall portion, respectively circumferentially closed around these wall portions, when it concerns singular surfaces.

Thus, preferably, the drum is configured so that it has a cylindrical shape in the upper portion, and, however, so that it tapers conically in the lower portion to the outlet, centrally disposed at the lowest point, and so that the conically tapering wall portions are thus preferably configured as partially permeable wall portions, thus from the non-permeable spout of the outlet to the cylindrical wall portions disposed there above. Since the permeable wall portions are in this case annular, circumferential permeable wall portions, a hose shaped foil is being used as cover foil, which is mounted circumferentially tight above and also below the permeable wall portions, thus in this case on the outside of the outlet spout, and on the outside of the cylindrical wall portions above the cone.

Thus, it is important, that the protective foil is configured long enough in axial direction, so that the drum can be completely removed from a surrounding container, e.g. pressure container, also without removing the upper mount of the foil, though the upper attachment of the foil remains attached to said circumferential container, and the foil can thus be additionally sealed radially tight between the drum and the pressure container axially offset there from, e.g. through radial compression of the foil hose by means of a strong cable tie or another clamping device.

Also, the foil is mounted circumferentially to the desired external diameter, either of the drum or of the pressure container, by means of suitable, in particular, disengageable clamping devices, e.g. by means of a circumferential O-ring, or by means of a clamping belt, which can be tightened.

When the partially permeable portion of the wall is the conical portion, preferably also the foil covering this cone preferably tapers with respect to its diameter from the portion above the cone to the portion below the cone, so that the foil contacts the partially permeable portion substantially tight.

However, it is important that the foil comprises a hose shaped circumferential upper projecting length beyond the upper mounting location at the drum. The function of the projecting length is to facilitate offsetting the drum from the receiving protective container or pressure container.

In particular, said upper protruding length, preferably, however, the entire hose shaped foil, comprises a larger diameter than the external diameter at which the foil shall be kept at a tight contact, thus, in particular, of the outer diameter of the pressure container at the location where the upper overhang of the foil shall be mounted.

For mounting close to the outlet, the outlet is configured so that it's opening or closing does not influence the foil or its clamping device mounted close to the outlet. Thus, the outlet can be opened and closed without affecting the close contact of the foil on the outside of the outlet spout.

Typically, the outlet is closed tight by an outlet closure in such mixers, which outlet closure is disposed in the interior of the outlet spout so it seals tight, and which preferably comprises a convex curvature of its face towards the interior of the drum. For opening the outlet, the outlet closure is displaced into the interior of the drum, so that the content can run out past the closure through the open spout following gravity.

On the other hand, the upper protruding length is mounted by means of another circumferentially tight attachment, thus by means of a clamping device at the outer circumference of the lower end of the pressure container, so that a contamination tight space is created by means of the foil, which contamination tight space is formed by the outer portion of the pressure container and the foil, from which space only the outlet spout protrudes, which can also be closed contamination tight.

Within the foil, an air inlet opens within the upper portion of the pressure container, thus between the foil and the wall of the drum, through which air can be inducted under positive pressure, which flows on through the permeable portions of the wall of the drum into the drum, and swirls the mixing material around, which causes fine mixing.

In order for the inflowing air not to be subject to turbulence at the foil, which is loose in the center portion, the pressure container comprises a vacuum connection in particular in the lower portion, in order to pull the foil disposed in the lower portion outward to the inside of the container, in order to thus facilitate the inflow of the mixing air.

The drum furthermore comprises one, most often, however, plural connection spouts, at which accordingly configured connection components, like e.g. a filter, a feeding spout or a measuring instrument or an additional component, can be attached, after the normally closed spouts have been opened.

Also, when attaching said connection components, the transition between drum and connection component, which is open during attachment, is in turn sealed by a hose shaped foil, which in turn is connected to the connection spout, and, on the other hand, mounted circumferentially tight at the end of the connection component to be attached, which end faces away from said connection spout, thus said attachment is performed before the respective connection spout is open. The closure plug or the closure system, which closes the connection spout, is only opened thereafter, so that the connection spout remains within the foil, as long as the connection component remains attached to the connection spout. Thereafter, the connection portion is removed from the connection spout again, wherein the foil still closes the gap created there between, and only closes the connection spout after the closure plug is disposed within the foil. The foil can be closed and disposed of, which is described subsequently.

Also, in this case, the hose shaped foil has to have sufficient length in axial direction, in order to facilitate removing the connection component from the connection spout, as far as possible, so that a tight radial closure of the foil is facilitated there between.

While the drum can either be selectively configured as a reusable component or also as a component to be used only once, the pressure container which needs to be configured very stable is too expensive to be used only once. The pressure container thus after having been used as an insert for a filled drum, and after the fine mixing has been performed within said drum, has to be prepared for reuse, thus in particular has to be decontaminated.

For this purpose, a cleaning hood is available, which after removing the lower portion of the pressure container is placed onto its top from below, and can be connected tight therewith. Said cleaning hood includes a flushing device in its interior and an outlet in downward direction for the flushing device.

Furthermore, the cleaning hood comprises a disposal opening, which is large enough for passing a fist through, and which is disposed proximal to the portion where the residual foil is disposed, which remains on the upper portion, after the cleaning hood is placed onto the lower portion of the pressure container.

Additionally, a decontamination device is available, which fits onto the disposal opening of the cleaning hood, and by means of which, the residual of the disposal bag, which is disposed there and at other places, can be disposed contamination free. An analogous decontamination device is provided which is adapted to the connection spouts at the upper side of the mixing drum.

With these components, the following procedure for contamination free loading and unloading of a mixer can be performed:

Before the particular mostly powdery components of the powdery mixture to be produced are put into the drum, the wall portion of the drum which is configured partially permeable in order to press mixing air into the drum through there later is covered by a foil, e.g. a hose shaped foil, and mounted removed from the partially permeable wall portions circumferentially tight at the outside of the drum. Subsequently, the drum can be subjected to a coarse mixing through rotating or performing a tumbling movement.

Subsequently, the mixture thus produced can be emptied from the drum by placing the drum with its outlet into an accordingly configured outlet spout and opening the outlet. Since the foil does not extend beyond the outlet, but e.g. is mounted circumferentially tight at the outer circumference of the outlet spout, the sealing effect of the foil is not impaired or interrupted by the outlet process.

Often, however, a fine mixing has to be performed in addition to the coarse mixing performed by the movement of the drum, through force inducting mixing air through the partially permeable wall portions into the interior of the drum.

In this case, the force inducted mixing air also has to be able to leave the drum, in order not to build up positive pressure in the drum. For this purpose, a respective filter insert is placed onto connection spouts, particularly provided mostly in the upper face of the drum, through which filter insert, the mixing air can leave the drum without removing components of the mixture from the drum.

In order to avoid a contamination of the environment, when opening and placing the connection spout and subsequent connection of the connecting components, like e.g. a filter insert, in turn a sealing is performed by means of a hose shaped foil.

While the connecting spout is still closed, the foil is, on the one hand, connected to the outer circumference of the outlet spout, and, on the other hand, connected circumferentially tight at the end of the connection component, which has already been moved closely, which end is facing away from the connection spout. Only thereafter, the closure of the connection spout is opened, and thus opened within the foil, and left there, and thus during the entire time, in which the connection component, like e.g. a filter insert, remains placed on the connection spout.

In the same way, a feeding spout is placed tight at another of the connection spouts after a sealing has been performed previously by means of a hose shaped foil.

Inducting mixing air into the drum is typically performed only when the drum has been previously received in a pressure container, in order to receive the explosion pressure with the pressure container in case a dust explosion occurs in the interior of the drum.

The pressure container is thus mostly configured approximately cylindrical or egg shaped, and separable in the center portion of its longitudinal axis into an upper portion and a lower portion. The mixing air is then fed e.g. through an orifice, e.g. to the free end of the upper portion, which provides free access to the interior of the pressure container. For this purpose, said orifice is disposed e.g. in an annular flange radially moved backward in inward direction.

When the drum at whose outer circumference the foil is mounted is inserted into the upper portion of the pressure container from below, the upper attachment of the foil is still disposed outside of the upper portion of the pressure container. The upper longitudinal protrusion of the foil, which protrudes beyond said upper attachment, however, is sufficiently long in order to be mounted on the outer circumference of the upper portion of the pressure container, which is already disposed outside of the outlet for the fresh air, e.g. on the outer circumference of the radially inward recessed annular flange at the lower end of the upper portion. Since the foil is not circumferentially mounted thereon, the lower component of the pressure container can be placed tight against the upper component. If connection components are placed against the drum, the mixing drum comprises connection adapters at the respective positions and in the respective size, which fit tight onto the drum disposed in the pressure container, and onto the connection components disposed therein.

Now before pressing mixing air through the pressure container into the drum, the foil is sucked to the inner surface of the pressure container through a vacuum connection in the portion of the foil, thus mostly in the lower portion of the pressure container, so that a sufficient distance is maintained between the foil and the outside of the drum for inducting initially to the partially permeable wall portion and from there into the interior of the drum.

For this purpose, before force inducting mixed air and after mounting the upper longitudinal protrusion of the foil at the outer diameter of the pressure container, the upper attachment of the foil at the drum is disengaged, which releases the required pass-through for the mixed air.

Thus, the mixing material in the drum can be subjected to a fine mixing through force inducting mixing air into the drum, or also other processing steps, e.g. granulating, which is performed through the addition of moisture through the feeding spout. Also, feeding granulate with a sliding layer at the outer circumference of the granulate particles is possible through the additional induction of a mostly liquid lubricant through such a connection spout.

When all the intended processing steps of the mixing material are performed in the drum, the drum can be removed from the pressure container and emptied subsequently, which is performed as follows:

Certainly all methods and functional features described with respect to the upper component of the pressure container can also be provided instead at the lower component and vice versa.

The drum can thus be removed from the upper portion of the pressure container without disengaging the attachment of the upper protrusion of the foil from the outer diameter of the upper component of the pressure container. As a prerequisite, the foil is sized sufficiently long in axial direction, in order not to be able to take the drum completely out of the upper component of the pressure container, but in order to be able to additionally compress the hose shaped foil so it seals in radial direction at one or also at two axially offset closing locations.

Subsequently, the tightly closed foil is separated at one closing location or between the two closing locations, so that a residual foil remains at the upper component of the pressure container, the main portion of the foil, however, encloses the separated drum completely tight besides the outlet at the drum. Thus, the drum which is still full can be transported to a removal spout or similar, onto which the drum is placed tight with its outlet, and subsequently the closure plug of the outlet of the drum is opened and the drum is emptied.

Depending on the drum being configured as a reusable component or as a disposable component, the drum which is still received tight in the foil besides the outlet is subsequently provided to a correct disposal or to a reprocessing facility.

The pressure container, however, has to be reused and has to be decontaminated for this purpose. This is performed by putting a cleaning hood over the upper component of the pressure container still provided with the residual foil, since only the upper portion of the pressure container could be contaminated while the lower portion did not have any connection to the possibly contaminated inside of the foil.

The cleaning hood comprises the opening which is large enough to put a fist through. Said disposal opening is close enough to the position of the residual foil when the cleaning hood is disposed at the upper component, so that one can reach through the disposal opening, and grab the residual foil and pull it off from the upper component, possibly after disengaging the upper clamping device, through which the residual foil is still attached at the outer circumference of the upper component.

This is not performed with the bare hand, but using a disposal bag as a glove, which is mounted with its open side tight at the outer circumference of the disposal opening. The residual foil is thus pulled through the disposal opening to the outside of the cleaning hood, and is then enclosed in the disposal bag, which can now be compressed radially tight and separated between the residual foil and the disposal opening at least at one closing location.

Thus, the residual foil is tightly enclosed in the disposal bag, and the open side of the upper component, which is freely accessible now, and also the entire inner surface of the upper component of the pressure container are cleaned by means of the flushing device in the interior of the cleaning hood, when during the cleaning process which has to be performed now.

Thus, the upper portion of the pressure container is ready for use.

If the rest of the disposal bag remaining at the cleaning hood poses a contamination threat, a decontamination device can also be placed onto this disposal opening from the outside, which decontamination device in turn comprises a washing device in the interior and a outlet for washing fluid, and on the opposite side, comprises another disposal opening of its own for connecting the disposal opening, at which disposal opening in turn a disposal bag can be mounted, which is then used as a glove for grabbing the residual of the first disposal bag.

Thus, the decontamination device is the same with respect to its function and application as the cleaning device; however, it is only placed onto another opening, thus onto the disposal opening of the cleaning device instead of placing it onto the open side of the pressure container.

Analogous decontamination devices can also be used for placement onto the connection spouts of the drum 1. After the respective connection components were initially pulled off in the same manner and then the foil disposed between the drum and the connection component is sealed radially tight and separated.

Thus, the foil employed is a thermoplastic foil, in particular a hot seal capable foil, so that separating can be performed by means of heat, and thus a welding of the separation location is simultaneously performed with the separation, which avoids a release of contamination from the foil spout between the open end and the next interface.

### c) EMBODIMENTS

Embodiments of the invention are illustrated in the subsequent figures, wherein:

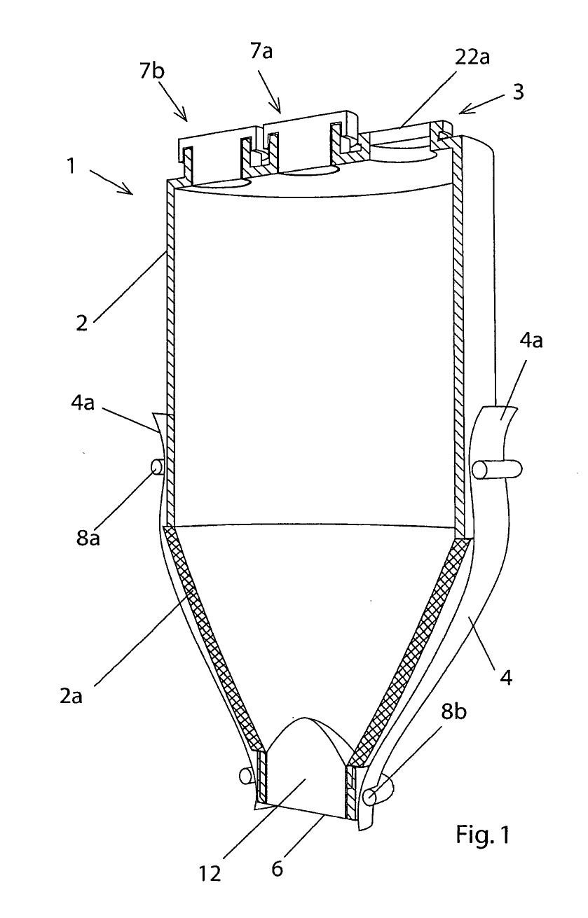

FIG. 1 shows the mixing drum in empty condition;

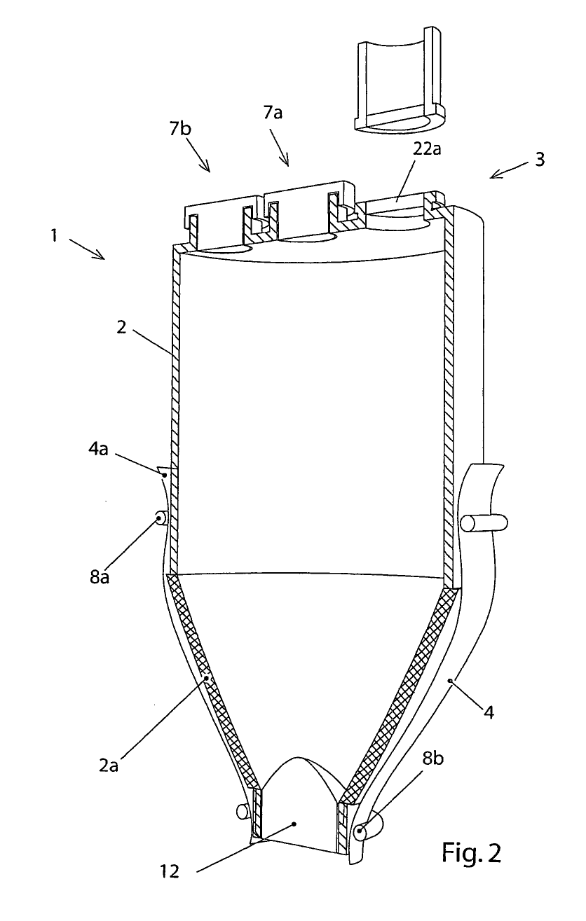

FIGS. 2-4 show the filling process;

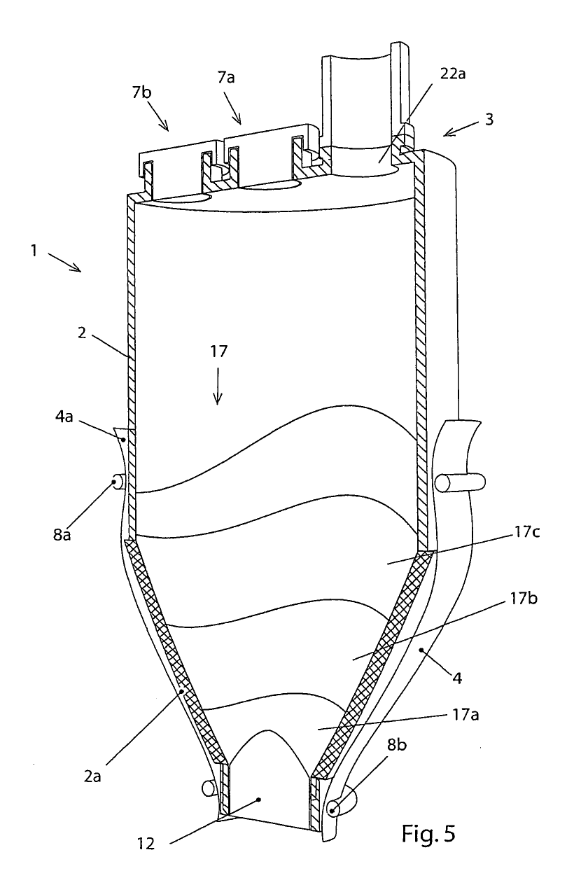

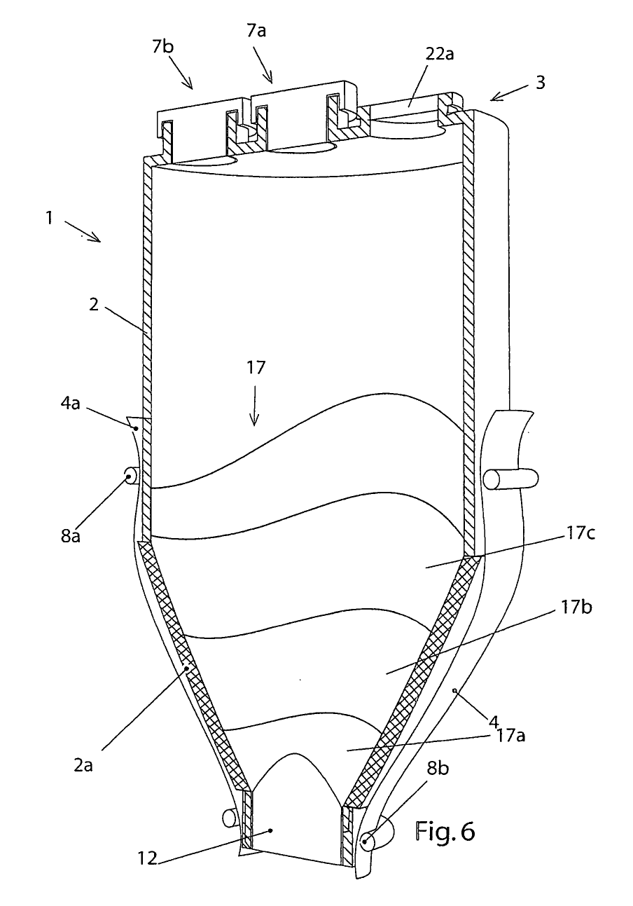

FIGS. 5 and 6 show the filled condition;

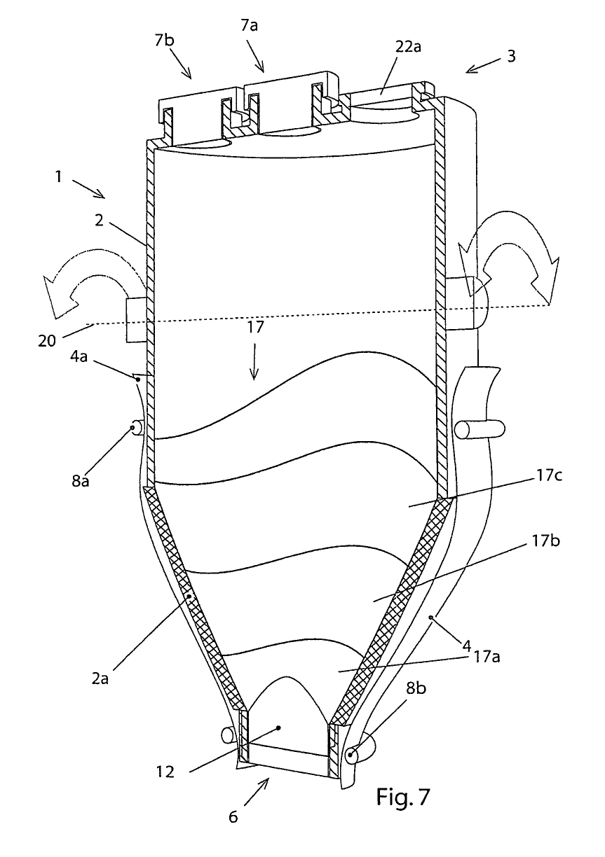

FIG. 7 shows the coarse mixing;

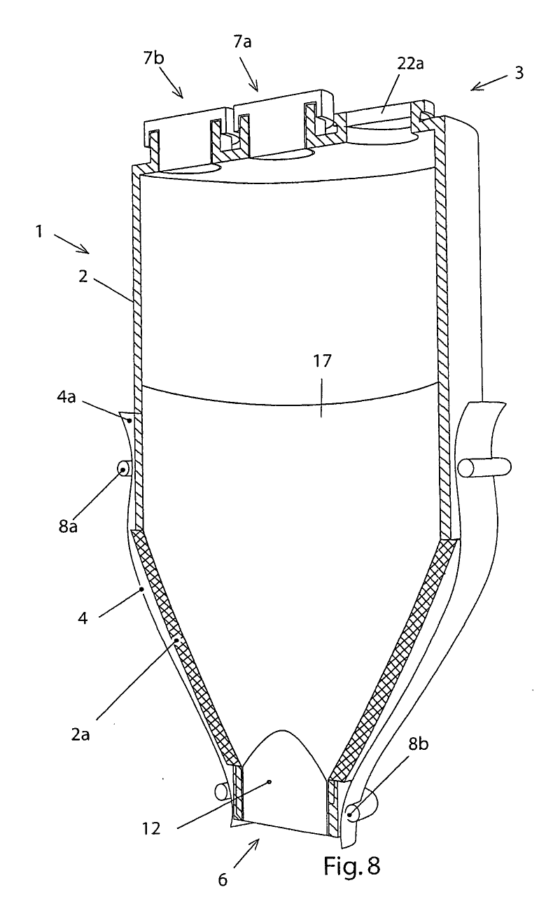

FIG. 8 shows the coarsely mixed condition;

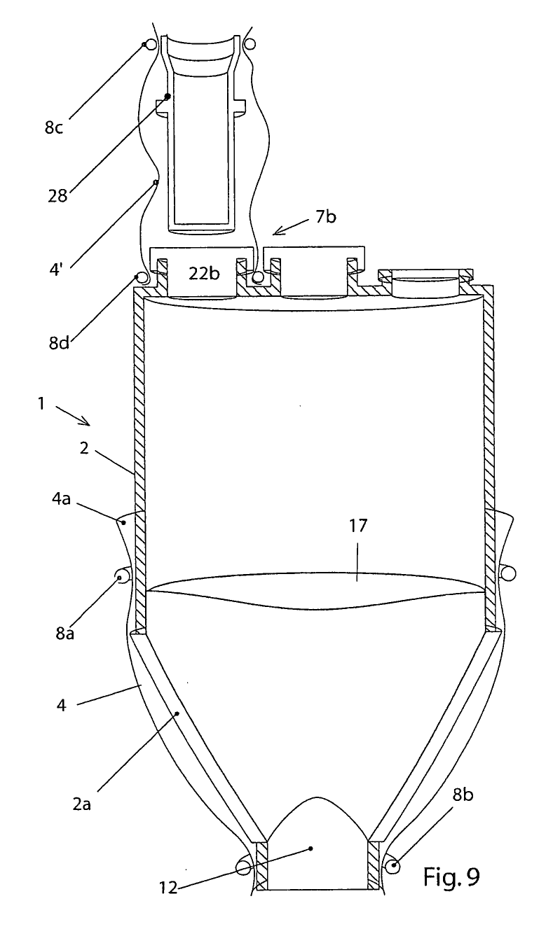

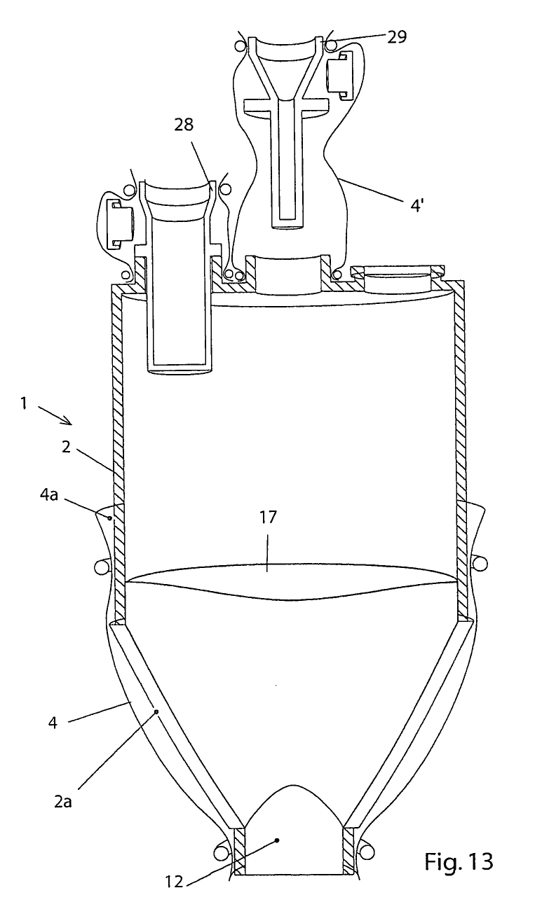

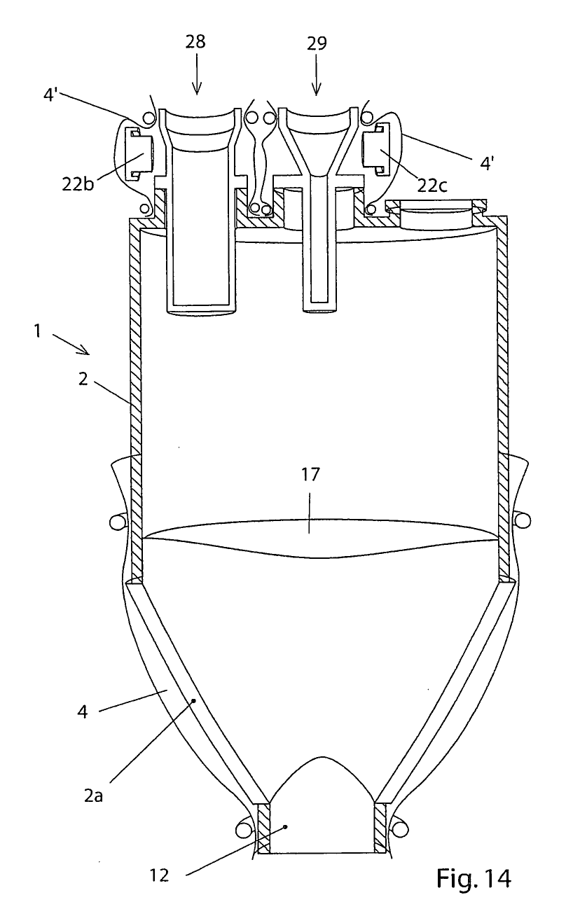

FIGS. 9-14 show placement of attachment;

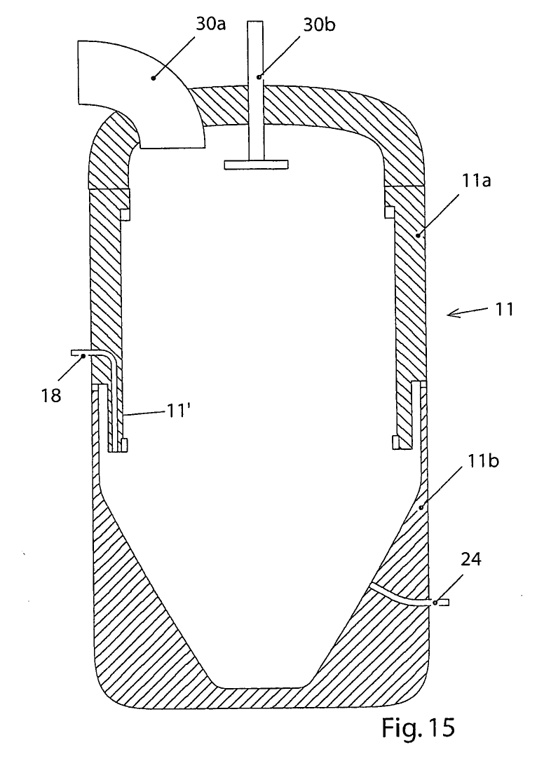

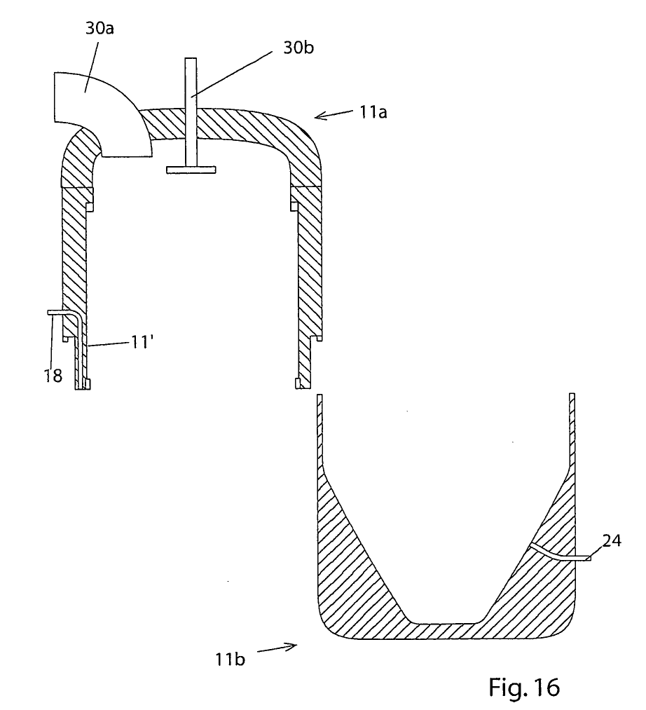

FIGS. 15 and 16 show the pressure container;

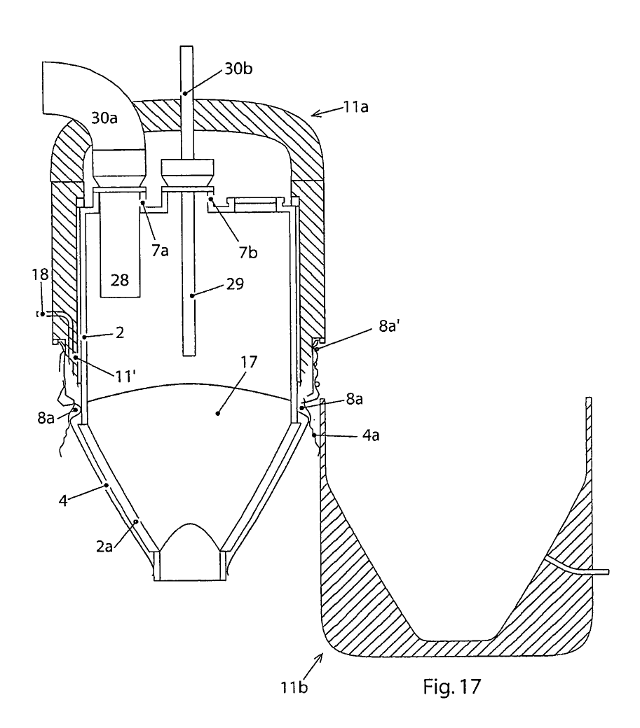

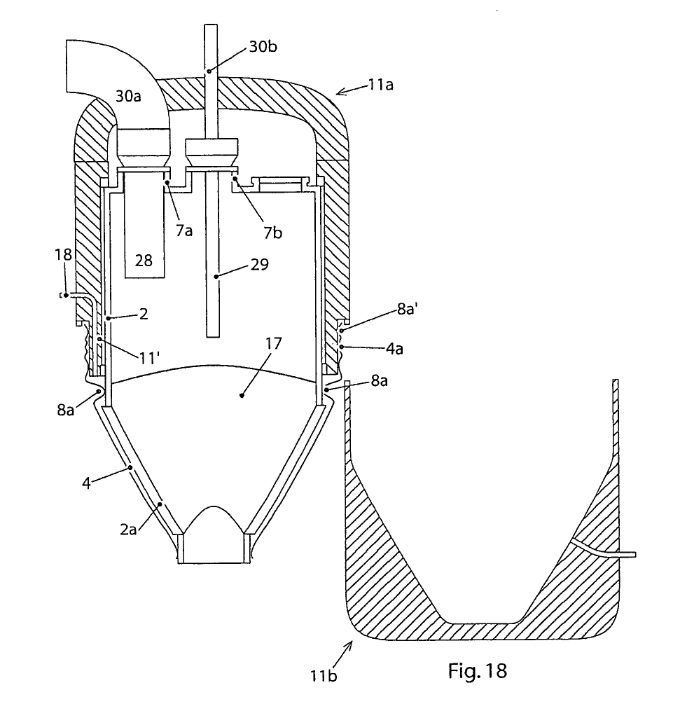

FIGS. 17-21 show the insertion of the mixing drum into the pressure container;

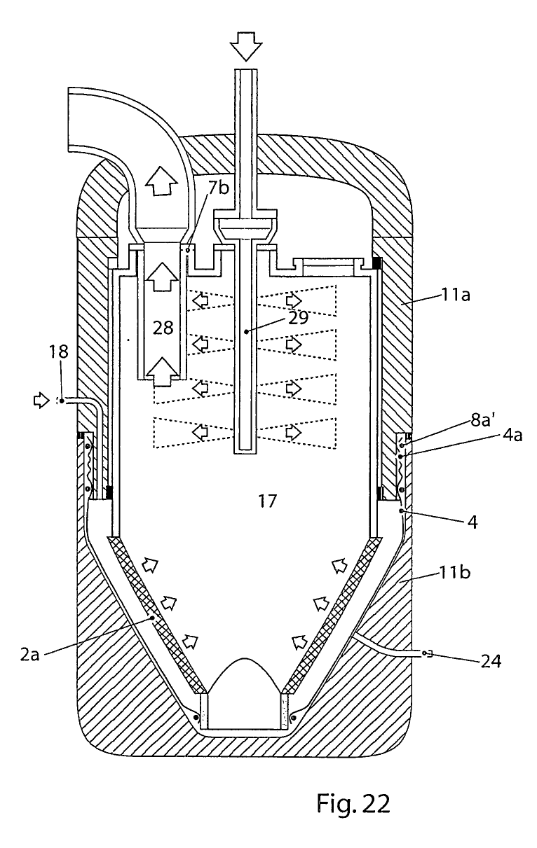

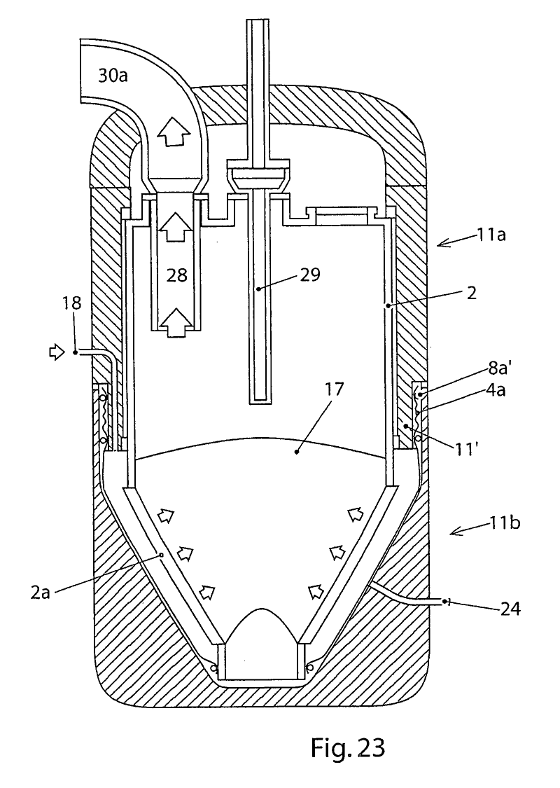

FIGS. 22-24 show the fine mixing;

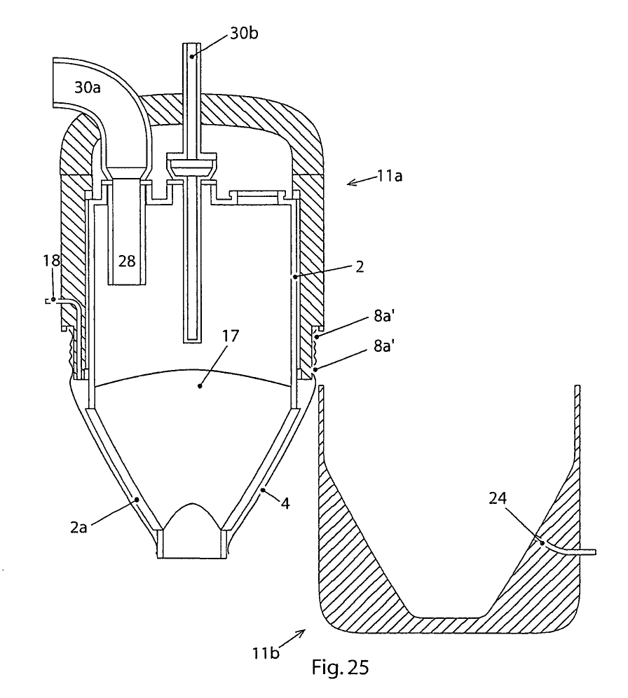

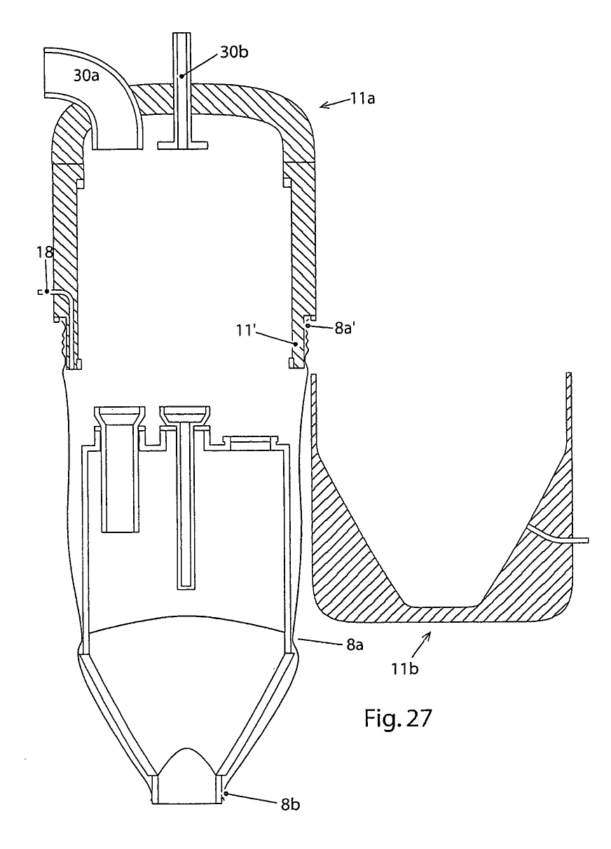

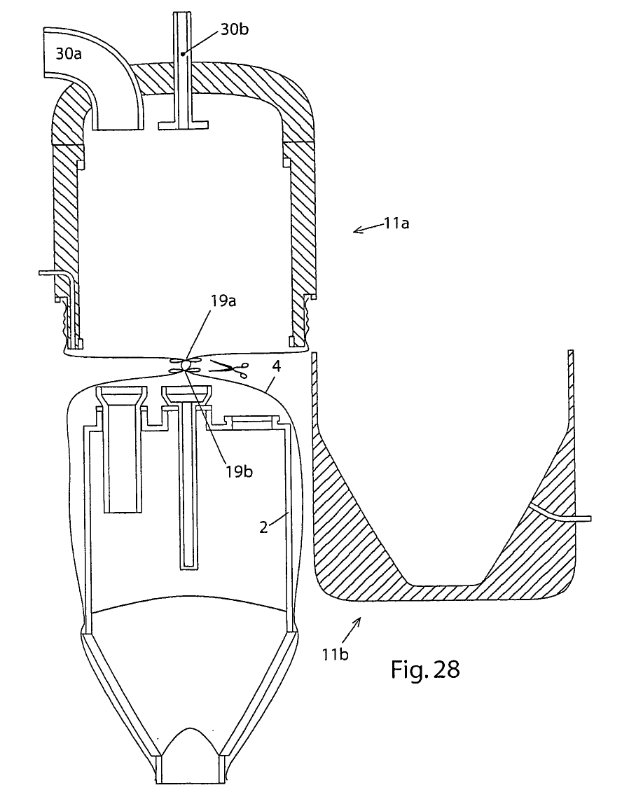

FIGS. 25-28 show the removal of the mixing drum;

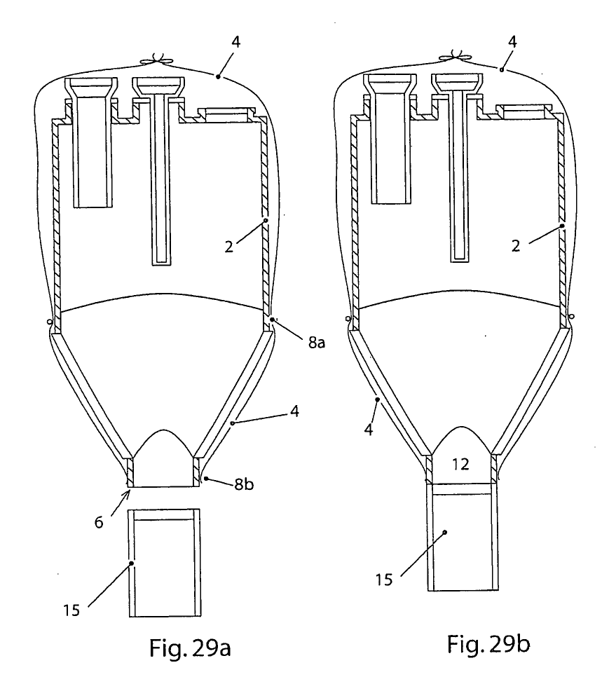

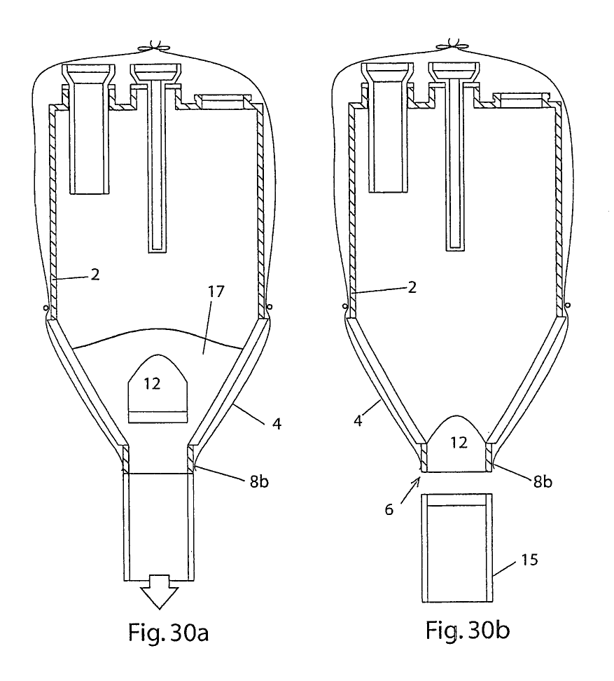

FIGS. 29 and 30 show the emptying of the mixing drum; and

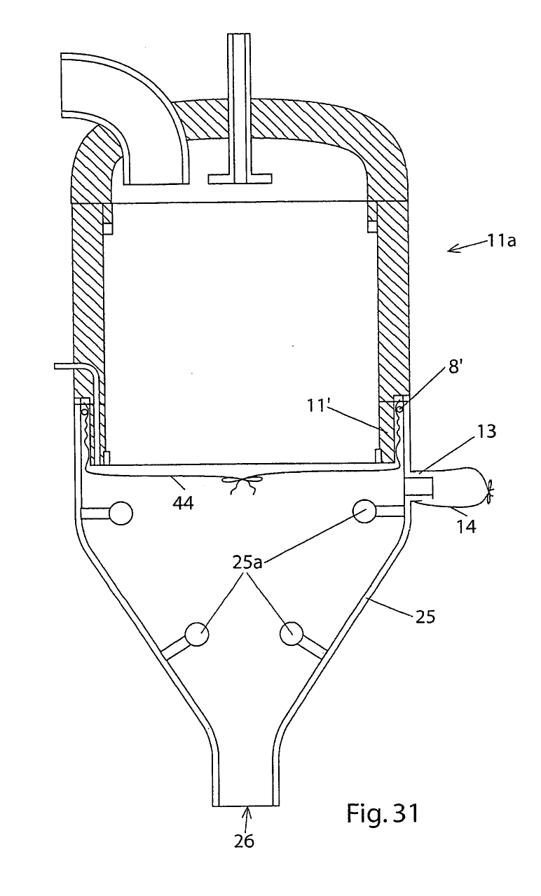

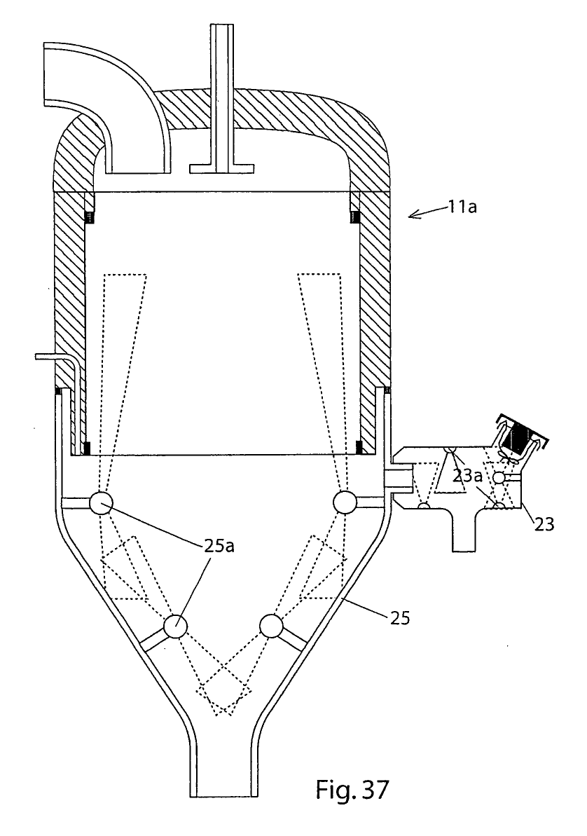

FIGS. 31-37 show the cleaning of the mixing drum.

FIG. 1 shows a mixer 1 only partially, thus the mixing drum 2, into which the particular components typically solids in the form of powder or in the form granulate of the mixture 17 to be generated are filled in one by one, and mixed through therein thereafter, and possibly processed further thereafter, e.g.
granulated;
the kernels of the granulate coated with a lubricant; and
wherein the granulate or the mixture shall be dried in advance.

The mixing drum 2 is configured cylindrical in the upper portion and tapers conically towards an outlet 6 in the lower portion.

A portion of the walls of the drum 2 is partially permeable, thus the conical wall portion 2a from the cylindrical portion of the drum 2 up to shortly before the outlet 6.

Said wall portion 2a should not be permeable for the components of the mixture 17 in the interior of the drum 2, which is still illustrated in empty condition in FIG. 1; however, it should be permeable from the outside to the inside for air to be blown in, which air is subsequently required for fine mixing. However, it cannot be excluded with 100% safety that the smallest amounts of the mixture 17 can also pass through in the opposite direction, thus from the inside to the outside, through said wall portion 2a, which is typically made of a sinter material.

When these are toxic materials or e.g. materials which are undesirable in the environment due to cross contamination, these can lead to substantial disadvantages.

The mixing drum, on the one hand, comprises an inlet 3 provided as a spout, which can be opened and closed by a closing plug 22a.

Next to it, there is at least one connection spout 7b for applying a filter to the upper face.

Said filter is required in case air is inducted into the drum 2, in order to let superfluous air egress from the drum through such a filter, without removing components of the mixture.

Furthermore, there is a connection spout 7a in the upper face for letting additional components in, e.g. liquids for granulating a powdery substance or a liquid lubricant for applying to the outer surface of the granulate kernels.

At the lower conically tapering end, the outlet 6 can be closed by an outlet closure 12 as illustrated in FIG. 1. The outlet closure 12 thus mostly comprises a drum 2, curved in a convex manner into the interior of the drum 2, and is located in the tubular, lower end of the mixing drum 2.

FIG. 1 furthermore shows that the conical wall portions are configured as partially permeable wall portions 2a; as will be described in detail later, this is required in order to force feed large volumes of air also with a positive pressure from the outside through said partially permeable wall portion 2a into the drum 2, and to swirl the mixture 17 provided at this location through the air flow, thus providing the mixing. The air induction is not only used for mixing, but also for drying after granulating or for swirling the product around during coating.

Since it cannot be excluded with 100% reliability that components of the mixture penetrate to the outside through said partially permeable wall portions 2a, as long as all other inlets and outlets are closed correctly, said wall portions 2a are covered circumferentially by a hose shaped foil 4 on the outside of the drum 2, which are pressed on tight above and below the partially permeable wall portion 2a; in this case, on the one hand, on the cylindrical exterior diameter, and, on the other hand, onto the outlet spout, wherein the tight pressing is performed over the entire circumference along the outer surface of the drum 2.

Thus, it is important that the hose shaped foil 4 comprises an upper length protrusion 4a beyond the upper clamping device 8a, whose function is described subsequently.

The following figures show the sequence when producing a mixture 17 in said drum 2 of a mixer 1, and possibly additional process steps:

FIG. 2 shows approaching a filling spout from the outside to the inlet 3, which is still closed by the plug 22a in FIG. 2.

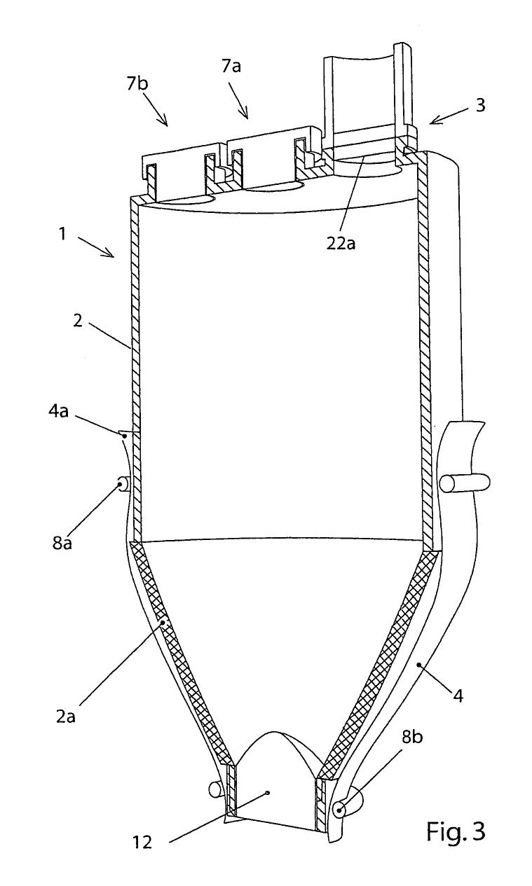

In FIG. 3 the filling spout already contacts the inlet 3 tight, which inlet is still closed.

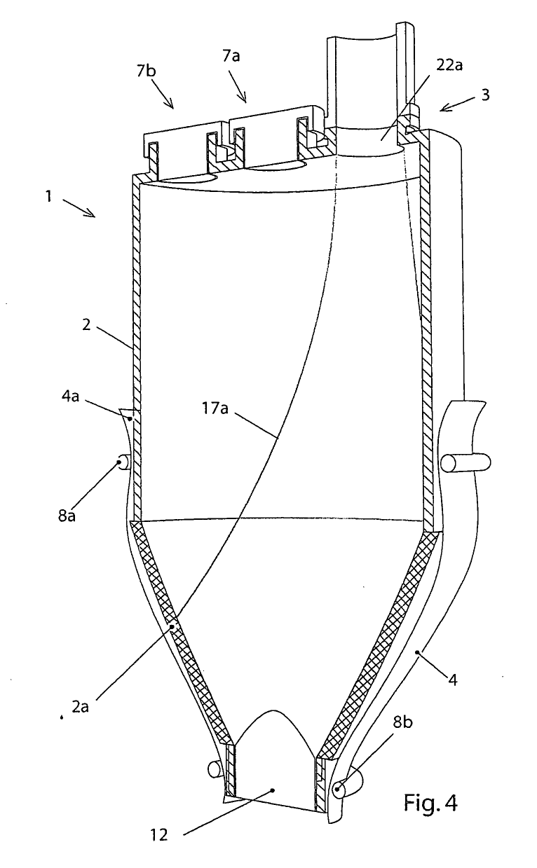

Subsequently, the closing spout 22a of the inlet 3 is being opened and possibly also the closure plug of the filling spout, if it is closed separately and the first component 17a is filled into the drum 2 according to FIG. 4, wherein all other openings of the drum 2 are preferably closed.

Thus, the particular components of the mixture 17 to be made are filled in through the inlet 3, wherein possibly changing the inlet spout is required, which is then respectively performed in a manner so that the inlet spout is only removed from the inlet 3 when it is sealed tight by its closing plug 22a.

When the particular components are filled in, in this manner, as shown in FIG. 5, the inlet 3 is closed by the closing plug 22a again, and the filling spout is then removed so that the particular components are still stored in layers on top of one another in the drum 2.

Subsequently, a coarse mixing of the mixture 17 is performed according to FIG. 7 by rotating the drum 2 about its axis of rotation 20 or performing a tumbling movement in order to provide a coarse mixing of the content of the drum, which is as even as possible, as illustrated eventually in FIG. 8.

The mixture 17 thus coarsely produced through the mechanical tumbling movement shall be mixed even finer, and thus through force inducting air through the partially permeable wall portions 2a.

Air thus inducted has to be able to escape from the drum 2, which is otherwise closed. For this purpose, a filter insert 28 shall be placed onto the connection spout 7b.

FIG. 9 shows disposing the filter insert 28 close to the connection spout 7b, which is still closed by a closing plug 22b. Even before said closing plug 22b of the closing spout 7b is opened, a foil 4′ which is in turn hose shaped is mounted on one side at the outer circumference of the connection spout 7b, and on the other side on the outer circumference of the end of the filter insert 28, which faces away there from, circumferentially tight by means of a suitable clamping device 8c, d.

The closing plug 22b disposed in the connection spout 7b is thus also disposed within the foil 4′, and both its circumferential attachments.

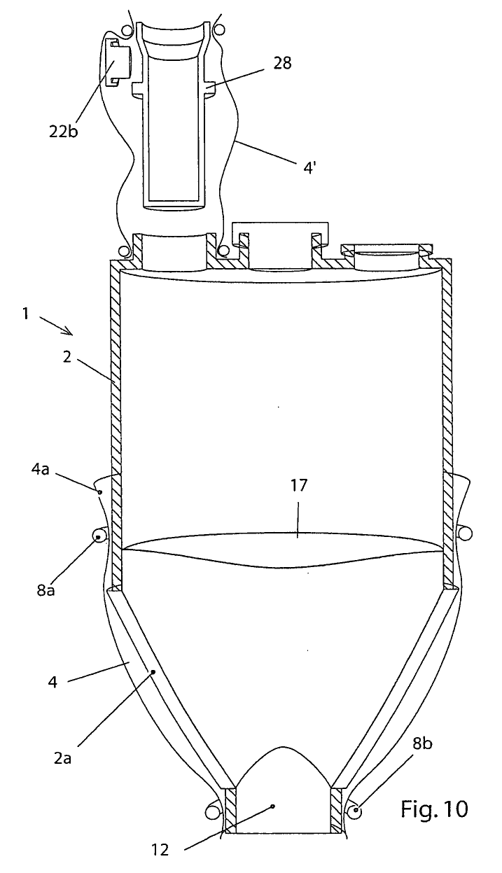

Subsequently, according to FIG. 10, the closing plug 22b is opened first and thus, so that it can still be supported within the foil 4′ and its two circumferential mounting portions, for which purpose the foil 4′ has to be sufficiently sized with respect to its diameter and axial length. Typically, the actuation of the closing plug 22b is controlled from the outside by a mechanism, which is not shown here.

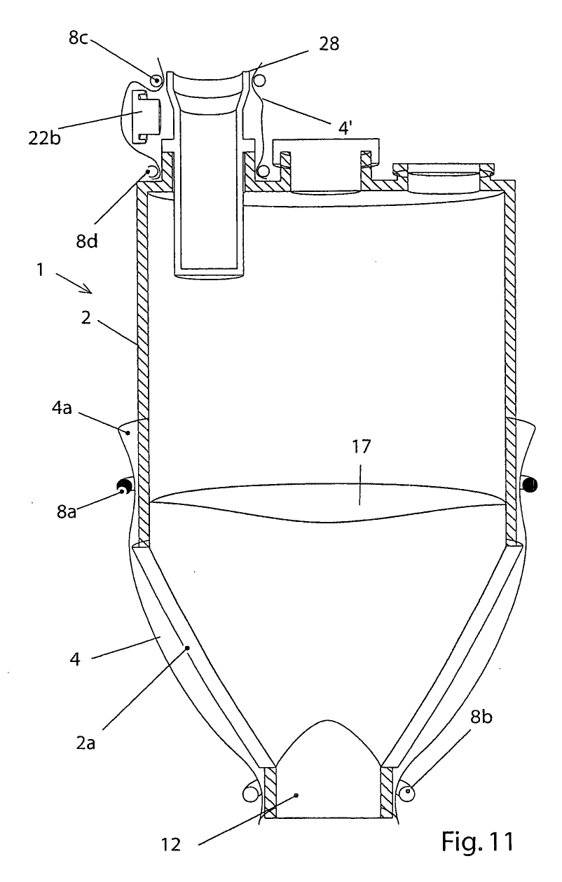

Subsequently, the filter insert 28 is placed tight onto the connection spout 7b and fixated according to FIG. 11. Thus, when air exits subsequently from the interior of the drum 2 through the filter insert 28, the components of the mixture 17 remain in the filter insert 28. When components of the mixture 17 have exited from the open connection spout 7b and placement of the filter insert 28, they are disposed within the tightly contacting circumferential foil 4′.

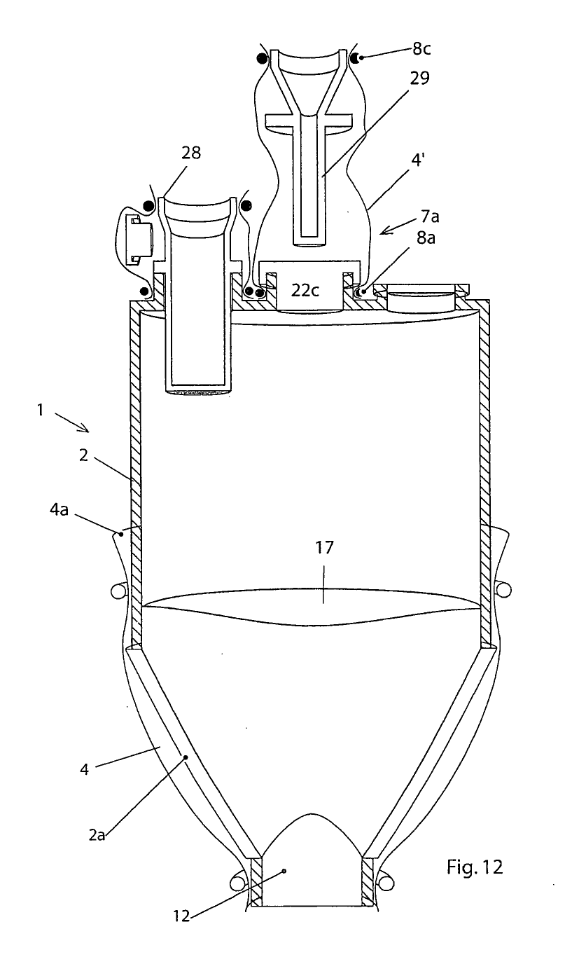

It is shown in FIGS. 12-14 how a feeding spout 29 can be placed onto the connection spout 7a analogously, whose spout subsequently protrudes into the interior of the drum 2 by a certain length.

The feeding spout 29 is mostly used for inducting liquid into the interior of the drum 2 and comprises outlet openings and outlet nozzles at the front face in order to either induct liquid into the powdery mixture 17, thus causing a granulation, when additional air is blown into the interior of the drum 2, or to provide a granulate which has already been produced at the outer surface of the granulate kernels with a coating e.g. a lubricant which is often required in the pharmaceutical field.

The process with respect to mounting the foil 4′ and the point in time of opening the closing plug 22 is the same here as described with reference to the filter insert 28 in an exemplary manner.

Inducting air into the interior of the drum through the permeable wall portions 2a is performed for fine mixing of the mixture 17 or for granulating the mixture 17.

This is typically performed in the interior of a protective container, in particular of a pressure container 11, as it is shown by itself in FIG. 15 (closed) or FIG. 16 (open).

Such a pressure container 11 shall receive and absorb the explosion pressure in case a dust explosion occurs in the drum 2, which cannot be performed by the drum 2 due to its less stable construction, in particular when the drum is not provided as a non-reusable component but as a single use disposable component, and is thus configured less stable.

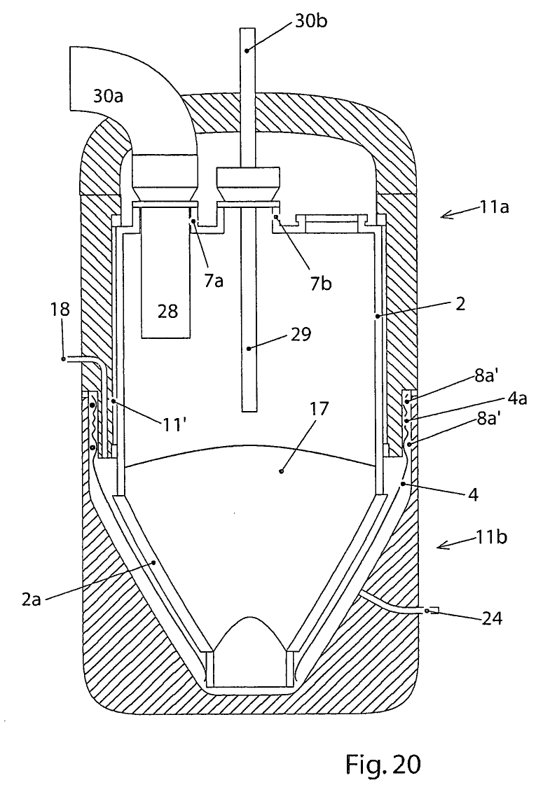

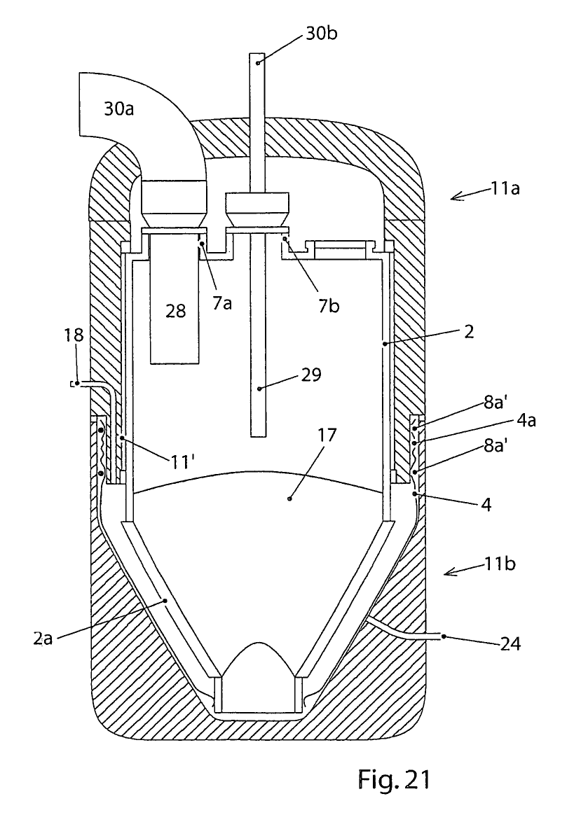

The pressure container 11 is configured approximately cylindrical as a hollow body, whose interior is sized so that the drum 2 fits into the pressure container 11 as shown in FIGS. 20 and 21.

The pressure container 11 is comprised of an upper component 11a and a lower component 11b, which can be fixated tight relative to one another.

In the upper portion 11a, connection adapters 30a, b are provided which are configured for those connection components which can be provided at the drum 2 at the connection spouts 7a, b, thus e.g. one or plural filter inserts 28, and a feeding spout 29, for which the respective feeding and emptying conduits are provided in the pressure container 11, which conduits certainly need to be connected tight to the respective connection components of the drum 2.

In FIG. 16 the upper component 11a and the lower component 11b are already shown separate from one another, so that according to FIG. 17 the drum 2 with its upper face with the connection spouts 7a, b can be inserted in forward direction into the upper component 11a, for which respective stops are provided in the upper component 11a for positioning.

Thus, the upper component 11a ends on the outside of the drum 2 shortly above the upper clamping device 8a, by means of which the foil 4 is attached at the outer surface of the drum 2 above the partially permeable wall portions 2a, and the protrusion 4a of the foil 4′ is folded over said clamping device 8a outward and downward, in order to avoid a collision with the lower edge of the upper portion 11a.

The lower rim of the upper component 11a is configured as an annular flange 11′, whose outer diameter is smaller than the outer diameter of the remaining pressure container 11.

With this diameter difference, the upper annular free end of the lower component 11b of the pressure container 11 is placed against the upper component 11a as illustrated in FIG. 20.

Before, however, the downward folded protrusion 4a of the foil 4 is placed upward onto said annular flange 11′ and mounted with another clamping device 8a′, at this location proximal to the other end of the hose shaped foil 4.

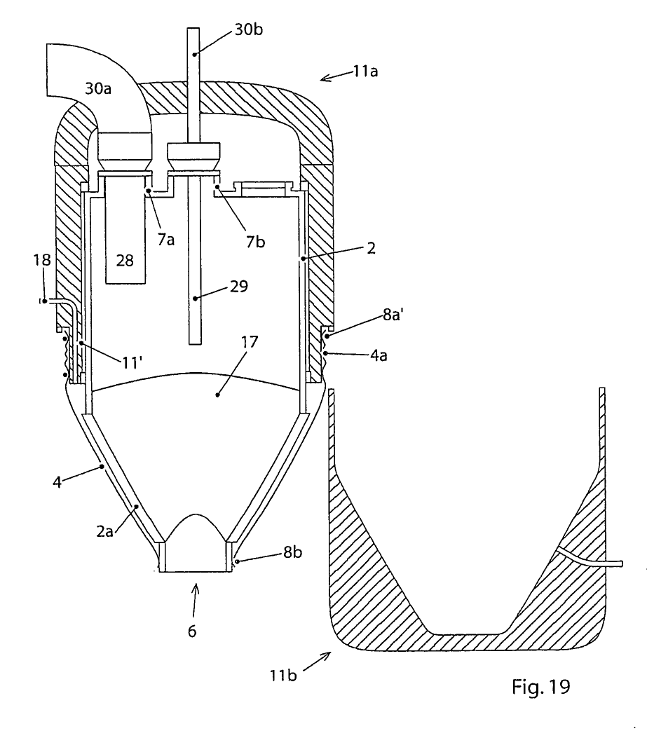

Preferably, two such suitable clamping devices 8a′ axially above one another proximal to the lower empty upper end of the annular flange 11′, and subsequently according to FIG. 19, the clamping device 8a, which was holding the foil at the outer circumference of the drum 2 above the partially permeable wall portions 2a, is disengaged.

These clamping devices 8a, 8a′ and 8b can be different types of clamping devices, as long as they only hold the foil 4 circumferentially tight at the desired exterior diameter. For example, respectively sized o-rings 5 or also clamping belts can be used.

Subsequently, the upper component 11a is placed against the lower component 11b of the pressure container 11 according to FIG. 20, so that now the entire drum 2 including the foil 4 and also the foils 4′, which are not drawn anymore in the FIG. 16 et seq. for reasons of clarity, which, however, are still provided including their clamping devices, are disposed within the pressure container 11.

FIG. 21 shows how vacuum is applied to the inner cavity of the pressure container 11 through a vacuum connection 24 in the lower component 11b in the portion of the foil 4, and thus the foil 4 is sucked outward to the inner circumference of the lower component 11b of the pressure container 11, in particular in the portion of the permeable walls 2a of the drum 2.

This is necessary in order to subsequently let large volumes of air flow in as shown in FIG. 22 through an air inlet 18, which opens in the face end of the annular flange 11′ of the upper component 11a, and thus through the offset between the foil 4 and the partially permeable wall portion 2a, which offset is now provided, without impairment through the foil 4 to the partially permeable wall portion 2a and through said wall portion into the interior of the drum 2.

Air thus force inducted into the interior of the drum 2 has to escape, in this case, through the connection spout 7b and the filter insert 28 inserted therein, wherein the components of the mixture 17 remain in the drum and are retained by the filter insert 28.

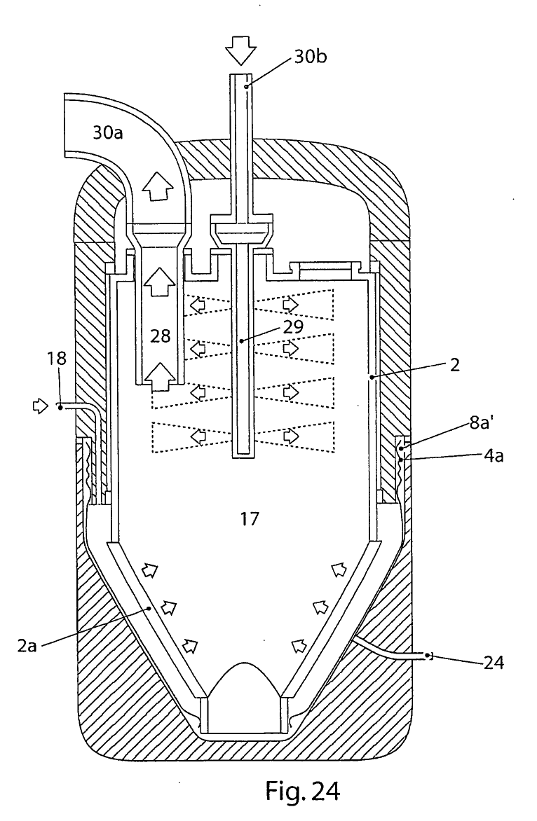

FIG. 24 shows how the content 17 of the mixer can be dried by passing drying air from the permeable wall portions 2a to the filter spout 28.

FIG. 24 shows how an additive, e.g. moisture for granulating, and/or a moist lubricant can be inducted through the feeding spout 29.

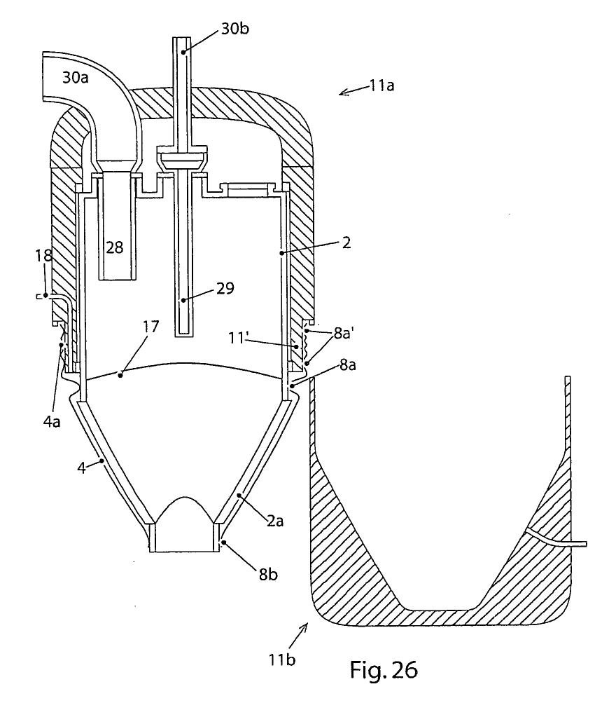

When all desired processes are completed in the interior of the drum 2, the lower portion 11b of the pressure container 11 is removed from the upper portion 11a according to FIG. 25, and according to FIG. 26, the upper clamping device 8a is reattached to the foil 4 at the outer circumference of the drum 2 or mounted circumferentially tight above the partially permeable wall portions 2a.

Eventually, and this is one of the most important steps of the invention, the drum 2 is is moved out of the upper component 11a of the pressure container 11 without disengaging the lower clamping device 8b on one side and the upper clamping device 8a′ of the foil 4 at the drum 2, thus proximal to the outlet 6 on the one side and proximal to the annular flange 11′ on the other side. If two clamping devices 8a′ are provided above one another in axial direction, the lower clamping device 8a′ mounted proximal to the free end of the annular flange 11′ is disengaged when necessary.

For this purpose, the foil 4 certainly has to be sized long enough in axial direction, in order to remain attached, on the one hand, to the upper attachment of the foil 4 through the clamping device 8a′ at the upper portion 11a of the pressure container, and, on the other hand, so that the lower clamping device 8b remains attached to the lower end of the drum 2.

In particular, a large axial length of the hose shaped foil 4 is required in order to subsequently compress the hose shaped foil 4 between the upper component 11a and the pressure container 11, and the drum 2 enclosed in the foil radially tight and closed at two closing locations 19a,b and subsequently separated between the closing locations.

The drum 2 is then provided tightly enclosed in the foil 4 as a component which can be handled separately and can e.g. be moved proximal with its outlet 6 downward to an outlet spout 15 and can be placed as shown in FIG. 29a,b.

After tight placement onto the removal spout 15, the outlet closure 12 may be opened together with the closure system of the outlet spout 15 generally by moving the outlet closure 12 axially into the drum 2, so that the generated mixture 17 can run out laterally into the outlet spout 15 in the gap between the outlet closure 12 and the surrounding wall of the drum 2 as shown in FIG. 30a, and the outlet closure 12 can seal the outlet 6 again tight, and the drum 2 which is closed again can be separated from the removal spout 15 (FIG. 30b).

All this is possible, since the outlet 6 of the drum 2 is not blocked by the foil 4, but the foil 4 with its lower clamping device 8b only ends on the outer circumference of the spout forming the outlet 6, and shortly below.

Thus, the contamination free feeding and also the emptying of the drum 2 is completed, and the drum 2 in case it is a reusable component can be provided to a processing and cleaning station in the condition where it is included in the foil 4, or when it is a disposable drum 2, it can be provided to contamination free disposal.

The component to be reused in any case is the pressure container 11, whose upper component 11a thus has to be cleaned and prepared for reuse, which is shown in the FIG. 31 and following.

At the annular flange 11′ of the upper component 11a, there is still the residual foil 44, which theoretically can be contaminated at its inside.

According to FIG. 31, a cleaning hood 25 is placed from the bottom to the upper side 11a of the pressure container 11, which comprises an installed flushing device 25a and an outlet 26 for the cleaning fluid.

The cleaning hood 25 furthermore comprises a disposal opening 13, which is positioned so that reaching through the disposal opening to the inside with a hand is possible, and the residual foil 44 can be pulled out, possibly after opening the upper clamping device 8′.

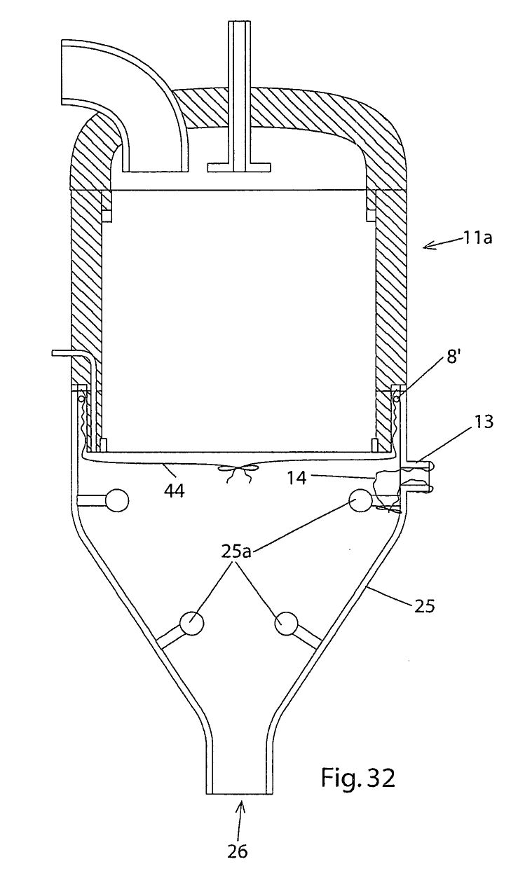

This is certainly not done with the bare hand (re. FIG. 32) but using a disposal bag 14 which is mounted tight with its open side on the outside of the disposal opening 13, and which can be used in the interior of the cleaning hood 25 for the described activities like a glove.

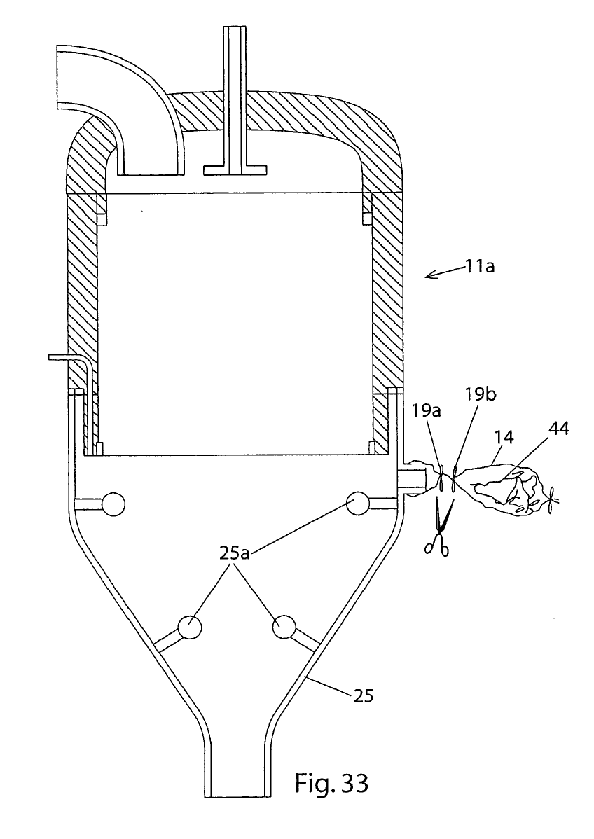

After pulling the residual foil 44 out it is disposed as shown in FIG. 33 in the interior of the disposal bag 14, so that the disposal bag 14 can be closed radially tied between the disposal opening 13 and the residual foil 44 received therein, preferably at two of said closing locations 19a, b, and can be separated there between, so that the residual foil 44 enclosed tight now can be handled as a separate component or disposed or treated further.

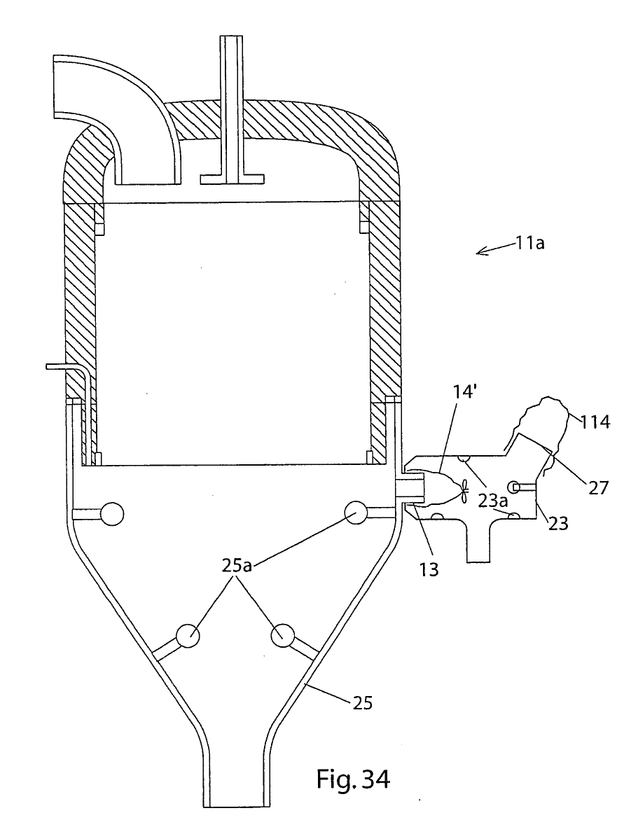

In case there is any concern that the residual bag 14′ remaining at the disposal opening 13 is still contaminated said residual bag 14′ can also be disposed contamination free in another step as illustrated in the FIGS. 34-37.

A decontamination device 33 (FIG. 34) is placed tight onto the spout of the disposal opening 13 and also placed precisely fitting over the residual bag 14′. Said device 23 comprises an engagement opening 27 opposite to the spout 23 onto which in turn an additional disposal bag 114 can be placed tight. In its lowest portion said device furthermore has an outlet 126 and a flushing device 23a is disposed in the interior of the device 23.

A person now reaches again with the disposal bag 114 as a glove into the device 23 and the residual bag 14′ is pulled off from the disposal opening 13 and pulled out of the device 23 into the interior of the other disposal bag 114.

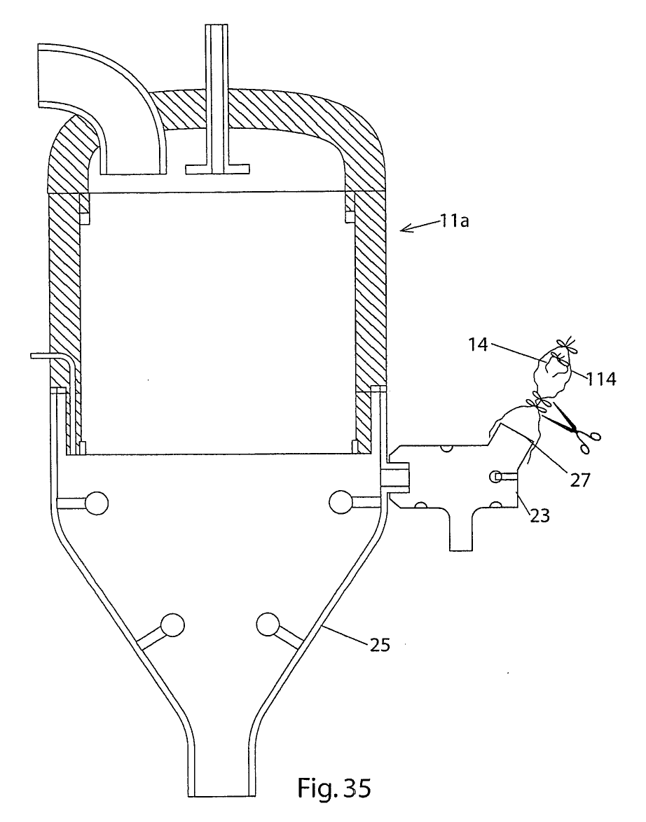

Subsequently the disposal bag 114 (FIG. 35) is closed tight between the engagement opening 27 and the enclosed residual bag 14′ and separated which closes the residual bag 14′ tight so that it can be treated further separately.

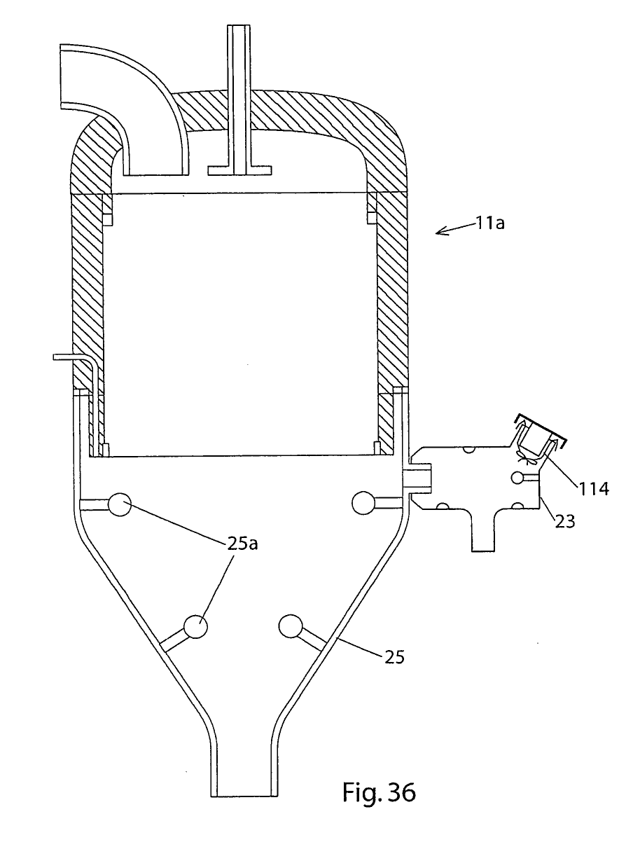

Preferably the engagement opening 27 is subsequently closed by a closure plug which shapes the remaining residual bag 114′ convex inward (FIG. 36).

Then the interior of the decontamination device 23 can be flushed and thus decontaminated by itself and/or also together with the interior of the cleaning hood 25 and thus also of the upper component 11a by means of the flushing devices 25a, 23a installed respectively.

Used flushing fluid is removed through the outlets.

Thereafter the mixer 1 as well as the pressure container 11 and the decontamination device 23 are available for further use.

### REFERENCE NUMERALS AND DESIGNATIONS

1 mixer
2 drum
2a partially permeable wall portion
3 inlet
4, 4′, 4″ foil
4a upper protrusion
5 O-ring
6 outlet
7a connection spout inlet
7b connection spout filter
8a, b, c, d clamping device
9 cover
10 axial direction
11 pressure container
11′ annular flange
12 outlet closure
13 emptying opening
14, 14′ emptying bag
15 emptying spout
16 closure
17 mixture/mixing
18 air inlet
19a, b closure location
20 rotation axis
21 foil spout
22 plug
22a closing plug
23 decontamination device
24 vacuum connection
25 cleaning hood
25a flushing device
26 outlet
27a, b closures
28 filter insert
29 feeding spout
30a, b connection adapter
44 residual foil
114 disposal bag
126 outlet

1. A device for contamination free loading and emptying, in particular a mixer (1), with a mixing drum (2), comprising:
an inlet (3) and an outlet (6); and
an at least partially permeable wall portion (2a) for inducting drying air, which mixing drum is otherwise sealed completely tight,
a cover, which reaches over the partially permeable wall portion (2a) sealing it circumferentially tight, wherein
the cover is a flexible foil (4), which is removably attached outside of the partially permeable wall portions (2a), on the outside of the drum (2).

2. A device according to claim 1, wherein the at least partially permeable wall portion (2a) extends above the outlet (6). in particular conically expanding in upward direction.

3. A device according to claim 1, wherein the foil (4) is configured hose shaped and removably attached on one side circumferentially tight below and on the other side circumferentially tight above the partially permeable wall portion (2a), removably attached on the outside of the drum (2).

4. A device according to claim 1, wherein the device comprises a pressure container (11) into which the drum (2) fits.

5. A device according to claim 4, wherein the protective foil in axial direction (10) is long enough, so that the drum 2 can be completely removed from a portion of the pressure container (11) without removing the upper attachment, in particular at the outside of the pressure container (11) within the foil (4) and the foil (4) can be closed tight between the pressure container (11) and the drum (2).

6. A device according to claim 1, wherein the foil (4) is attached at the drum (2) by means of disengageable circumferential clamping devices (8a, b).

7. A device according to claim 6, wherein the clamping devices are comprised of a circumferential O-ring (5) or a circumferential tension belt circumventing the foil on the outside on the outer circumference of the foil.

8. A device according to claim 1, wherein the foil (4) tapers cone shaped from the portion above the partially permeable portion (2a) to the outlet (6).

9. A device according to claim 6, wherein the foil (4) comprises an upper overhang beyond the portion of the upper clamping device (8a).

10. A device according to claim 9, wherein at least the upper overhang (4a), in particular the entire upper portion of the foil (4) comprises a larger diameter than the outer diameter of the drum (2), in particular a larger outer diameter than the outer diameter of a pressure container (11), into which the drum (2) fits.

11. A device according to claim 6, wherein the outlet (6) is configured, so that its opening and closing does not impair the attachment disposed proximal to the outlet (6), in particular the clamping device (8b) of the foil (4) at the drum (2).

12. A device according to claim 1, wherein the outlet is closed by an outlet closure (12) disposed in the outlet spout and closing the outlet tight, which outlet closure is in particular in cone shaped and can be moved into the drum (2).

13. A device according to claim 4, wherein at least one additional clamping device (8c, . . . ) is provided on the outside of the pressure container (11, 12) for attaching the foil (4) circumferential tight on the outer circumference of the pressure container (11).

14. A device according to claim 4, wherein the pressure container comprises an air inlet (18), whose inlet is disposed radially between the outer circumference of the drum (2) inserted into the pressure container (11) and the inside of the foil (4) attached at the outside of the pressure container (11).

15. A device according to claim 4, wherein the pressure container (11) comprises a vacuum connection (24) in the portion of the foil (4) attached to the inserted drum for pulling the foil (4) to the inside of the pressure container (11).

16. A device according to claim 4, wherein the foil (4) has a sufficiently large diameter in radial direction, in order not to be disengaged from its tight attachment at the outside of the drum (2) or of the pressure container (11), when it is pulled against the pressure container (11).

17. A device according to claim 1, wherein the foil (4) is a thermoplastic hot sealing foil (4).

18. A device according to claim 1, wherein the drum (2) comprises at least one connection spout (7a, . . . ) at its upper side and a hose shaped foil (4″) is attached circumferentially tight respectively, on one side at the connection spout (7a, . . . ), and on the other side at the end of the connection component, inserted therein and facing away from it.

19. A device according to claim 18, wherein the protective foil is long enough in axial direction (10), so that the connection component can be completely removed from the one component of the connection spout (7a) within the protective foil 4, without removing the upper attachment at the outside of the connection spout (7a), and the foil (4) can be closed tight between the connection spout (7a) and the connection component.

20. A device according to claim 19, wherein the connection spouts (7a, b) can be closed by closures (27a, b), which are configured, so that they can be disengaged through the foil, when the foil (4″) is already attached at the connection spout (7a) and at the connection component, and the connection spouts (7a,b) can be supported within the foil in addition to the connection spout and can be inserted again in the connection spout (7a, . . . ).

21. A device according to claim 20, wherein the hose shaped foil (4″) is sufficiently sized in axial and/or radial direction in order to receive the closure (27a) in addition to the connection component therein, which closure closes the connecting spout (7a, . . . ).

22. A device according to claim 20, wherein the closure component is a filter insert (28).

23. A device according to claim 18, wherein the connection component is a feeding spout (29).

24. A device according to claim 4, wherein the pressure container (11) comprises a cleaning hood (25) for tight application to the upper portion (11a) of the pressure container (11).

25. A device according to claim 24, wherein the cleaning hood (25) comprises a flushing device (25a).

26. A device according to claim 24, wherein the cleaning hood (25) comprises a disposal opening (13), sized for passing a fist through and which is so close to the attachment of the foil (4) at the upper component (11a) of the pressure container (11), so that it can be grabbed by a hand, which is inserted through the disposal opening (13).

27. A device according to claim 4, wherein the pressure container (11) comprises a decontamination device (23) for tight application to the disposal opening (13).

28. A device according to claim 1, wherein the drum (2) is a drum for single use.

29. A method for contamination free feeding and emptying of a mixer with a mixing drum (2) comprising:
a) a foil (4) is attached about an at least partially permeable wall portion (2a) circumferentially tight at its outer circumference, so that the partially permeable portion (2a) is covered by the foil (4) on the outside, wherein the foil (4) comprises an upper length protrusion (4a) above the upper attachment;
b) the components are placed one after another into an otherwise tightly closed drum (2) through the open inlet (3), and the inlet (3) is closed;
c) the content of the drum (2) is coarsely mixed by moving the drum (2), in particular by rotating the drum (2) about its rotation axis (20), and/or tumbling the rotation axis (20);
d) the drum (2) enclosed tight in the foil besides the outlet (6) is placed onto an outlet spout (15) fitting to the outlet (6) and the outlet closure (12) is opened;
e) the mixture (17) is emptied from the drum (2) into the emptying spout (15) and the outlet closure (12) is subsequently closed; and
f) the drum tightly enclosed by the foil (4) is provided to a suitable processing device or to disposal.

30. A method according to claim 29, wherein the drum (2) filled with mixing material is inserted into an accordingly configured protection container, enclosing the drum (2), in particular a pressure container (11), by
placing the drum (2) into the upper component (11a) of the pressure container;
the upper protrusion (4a) of the foil (4) is attached on the outside of the upper component (11a), in particular a freely ending annular flange (11′) with a reduced outer diameter relative to the rest of the outer diameter, at least at one annular circumferentially tight attachment location;
the lower component (11b) of the pressure container (11) is placed tight against the upper component (11a) outside of the foil (4) and of the overhang (4a).

31. A method according to claim 30, wherein the foil (4) is sucked against the inside of the lower component (11b) of the pressure container (11) without the attachments of the foil (4) disengaging at the lower end of the drum (2) and on the outside of the upper component (11a) of the pressure container (11).

32. A method according to claim 30, wherein
the upper clamping device (8b) of the foil (4) is disengaged at the drum (2) above the partially permeable wall portion (2a), before the lower component (11b) is applied to the upper component (11a); and
air is force inducted into a gap between the foil (4) and the at least partially permeable wall portion (2a), in particular through the wall, in particular the annular flange (11′) of the upper component (11a) of the pressure container (11).

33. A method according to claim 30, wherein before inserting the drum (2) into the pressure container (11)
the connection component to be applied at this location is positioned on the outside and proximal to the at least one connection spout (7a) and a hose shaped foil (4″) is attached on one side at the connection spout (7a) and on the other side at the end of the connection component, which is facing away from the connection spout, circumferentially tight on their outer circumferences;
the closure closing the connection spout (7a) is opened within the foil (4″) and supported within the foil (4″); and
the at least one connection component is placed onto the connection spout (7a).

34. A method according to claim 30, wherein during insertion of the drum (2) into the pressure container, the connection components at the connection spouts (27a, . . . ) are connected tight to fitting connection adapters (30 a, b), leading into the pressure container.

35. A method according to claim 29, wherein the mixture in the interior of the drum (2) is dispersed, and fine mixing and/or drying of the mixture is performed by force inducting air, which penetrates through the at least partially permeable wall portions (2a) into the interior of the drum (2), and the mixing air is removed from the drum (2) through a filter insert (28) in at least one connection spout (7a) after closing the pressure container (11) about the drum (2).

36. A method according to claim 29, wherein additional substances (humidity, lubricant, etc.) for granulating, coating or other results are added to the mixture during fine mixing through a feeding spout (29) in one of the connections spouts (7b).

37. A method according to claim 30, wherein the foil (4) remains pulled against the inside of the lower component (11b) of the pressure container (11) in particular through loading with vacuum during the supply of mixing air.

38. A method according to claim 30, wherein the drum (2) is removed from the pressure container (11) by performing the following after removing the lower component (11b):
removing the drum (2) from the upper component (11a) without disengaging the upper and the lower mounting of the foil on one side, at the upper component (11a), and on the other side, at the outlet (6) of the drum (2), possibly with pulling off the upper protrusion (4a), stored on the annular flange (11′) of the upper component (11);
closing the hose shaped foil (4) radially tight between the upper component (11a) and the drum (2), at least at one closing location (19a, . . . );
separating the radially tightly closed foil (4) at the one closing location or between the two closing locations (19a, b);
moving the drum (2) tightly enclosed by the foil (4) to a removal spout (14).

39. A method according to claim 30, wherein disposing the residual foil (4′) remaining on the upper component (11a) of the pressure container (11) is performed by
applying a cleaning hood (25) configured to fit onto the upper component (11a) onto the upper component of the residual foil (4′);
grabbing the residual foil (4′) using a disposal bag (14), which is attached circumferentially tight on the outside of the disposal opening (13) of the cleaning hood (25) and which can be folded over into the interior of the cleaning hood (25);
grabbing the residual foil (4′) and pulling it outward through the disposal opening (13) into the interior of the disposal bag (14), possibly after disengaging the upper clamping device (8c) of the residual foil (4′) at the upper component (11a);
radially tight closing of the disposal bag (14) between the disposal opening (13) and the received residual foil at least at one, in particular two, offset closure locations (19a, b);
separating at or between the two closure locations (19a, b); and
moving the tightly enclosed residual foil (4′) for further disposal;
cleaning the interior of the cleaning hood (25) and the upper component (11a) connected therewith by means of the flushing device (25a) disposed in the cleaning hood (25); and
removing the flushing liquid through the outlet (26) of the cleaning hood (25).

40. A method according to claim 29, characterized by tightly applying a decontamination device (23) to the disposal opening (13) from the outside over the residual bags (14′) provided at this location;
receiving the residual bag (4′) in a disposal bag (14″) of the decontamination device (23); and
analogously tightly enclosing the residual bag (14′) and subsequently cleaning in the interior of the decontamination device (23) through a flushing device installed therein analogously to the process performed with the cleaning hood.
